(19) United States
(12) Patent Application Publication
(10) Pub. No.: US 2006/0271882 A1
(43) Pub. Date: Nov. 30, 2006

(54) Method for implementing a fuzzy spelling while inputting Chinese characters into a mobile phone

(75) Inventors: Cheng-Shing Lai, Taipei (TW); Long-Feng Ran, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/137,501

(22) Filed: May 26, 2005

(51) Int. Cl. G06F 9/00

(52) U.S. Cl. 715/816

(57) ABSTRACT

The present invention is to provide a method for implementing a fuzzy spelling, which gathers all the Chinese characters liable to be mispronounced or misspelled, classifies all these characters into different categories liable to be mispronounced or misspelled and stored them in a memory in a mobile phone in a form as a database cross-reference table, and enables the mobile phone to search all the characters from the database cross reference table corresponding to the mispronounced or misspelled Mandarin phonetic symbols being inputted by a user through a keypad of the mobile phone and display the same on a display unit of the mobile phone for the user to choose the correct Chinese character required.

### FIELD OF THE INVENTION

The present invention relates to a method of inputting Chinese characters into a mobile phone, more particularly to a method for implementing a fuzzy spelling while inputting Chinese characters into a mobile phone through searching out all the relevant distinct (correct) and indistinct (incorrect) Chinese characters liable to be mispronounced or misspelled for a user to choose the correct one.

### BACKGROUND OF THE INVENTION

In the living environment of present urbanized society featured in time-pressing living style, mobile telephones (or mobile phones) not only serve as a fast and convenient communication instrumentality, but are also incorporated in them a variety of additional functions such as game software, phone book service, voice mail system, alarm, etc., so as to provide additional services to users with the aim to upgrade effectively the functions of mobile phones to meet the users' requirement for having a multi-function mobile phone.

In order to facilitate mobile phone users in sending simple (or brief messages and compiling their own telephone directories, mobile phones are usually set up the methods of entering Chinese characters so as to enable the (Chinese speaking) users to enter Chinese characters based on the spelling of Mandarin phonetic symbols of that particular Chinese character. However, for those persons with poor (or nonstandard) pronunciation ability (or unable to make distinct (correct) phonetic spelling of Chinese characters), the methods of making phonetic spelling of Chinese characters will be the most difficult problem to them, and impact the efficiency of inputting correct Chinese characters as a result of the fact that they would often cause incorrect input of Chinese characters, which is fairly inconvenient for them.

### SUMMARY OF THE INVENTION

In view of the defect that the persons with poor (or nonstandard) pronunciation ability often spell incorrect Chinese characters and thus result in fairly low efficiency in Chinese character input, the inventor of this invention has, with the experiences and skills accumulated by him in his engagement in the business of manufacturing communication equipment and associated products in previous years, endeavored in the research of some methods for resolving the defect hereinabove set forth. Throughout his continuous research, experiments and improvements, this invention entitled “A method for implementing a fuzzy spelling while inputting Chinese characters into a mobile phone” has finally been developed and designed by him, so as to make it instrumental to remove the defect created by the prior art.

The primary object of this invention is to provide a method of realizing a fuzzy spelling while inputting Chinese characters into a mobile phone by a user so as to cause the mobile phone capable of maintaining the proper Chinese character input function by searching for the correct Chinese character to be shown on the display screen based on a misspelled or mispronounced Chinese character initially being entered by the user of the mobile phone.

In order to achieve the above-mentioned object, the method proposed herein is to gather all Chinese characters having similar and different pronunciations in different categories and to store the same in a memory in the mobile phone whereby a database can be established in the form of a cross-reference table containing a group of different Chinese characters for each single Chinese character liable to be mispronounced or misspelled, with which when a built-in micro-processor in the mobile phone receives a mispronounced or misspelled Chinese character inputted into the mobile phone by a user through a keypad provided on the mobile phone, the micro-processor will be capable of searching the cross-reference table for all the Chinese characters related to a particular group of different Chinese characters that are liable to be mispronounced or misspelled, and subsequently having such Chinese characters displayed on a display screen of the mobile phone. The mobile phone user may then choose a Chinese character from the display screen as the correct one needed to be entered into the mobile phone. Therefore, by using this method, even if a Chinese character is incorrectly pronounced or spelled by the user, he will still be capable of searching out and inputting the correct Chinese character needed in an easy and fast manner.

The above and other objects, features and advantages of the present invention will become apparent from the following detailed description taken with the accompanying drawings.

### BRIEF DESCRIPTION OF THE DRAWINGS

FIG. 1 is a block diagram of the present invention.

FIG. 2 is a flow-chart of the operation procedures of the method disclosed in this invention.

### DETAILED DESCRIPTION OF THE PREFERRED EMBODIMENTS

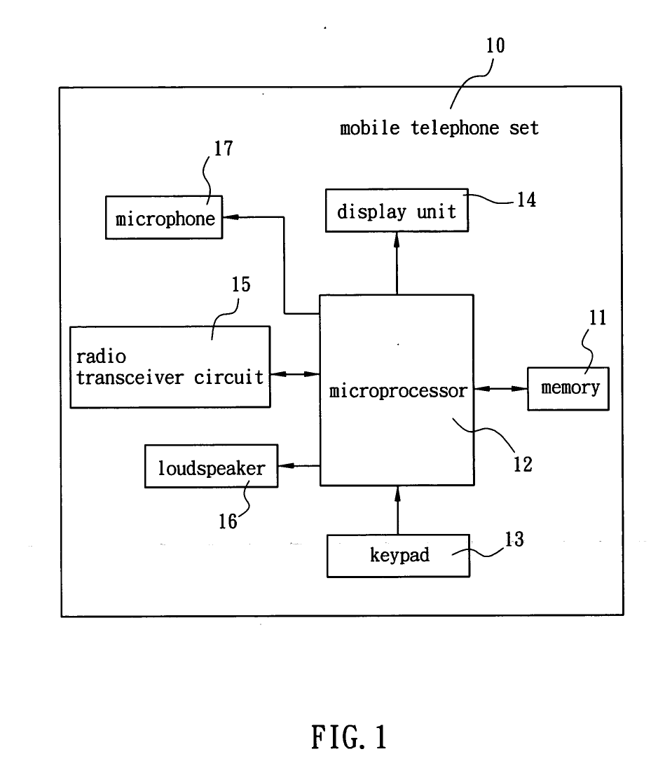

This invention is developed to provide a method for implementing a fuzzy spelling while inputting Chinese characters into a mobile phone through searching out all the relevant distinct (correct) and indistinct (incorrect) Chinese characters liable to be mispronounced or misspelled for a user to choose the correct one. As shown in FIG. 1, the method disclosed herein is primarily to gather all the Chinese characters related to a set of mispronounced or misspelled Mandarin phonetic symbols of a Chinese character needed by the user for inputting into his mobile phone. Such Chinese characters will be classified into different categories and stored in a memory 11 in the mobile phone 10 in a form as a database cross-reference table which serves as a database of relevant Chinese characters liable to be misspelled or mispronounced phonetically, whereby when a microprocessor 12 in the mobile phone 10 has received a set of incorrect spelling of Mandarin phonetic symbols (e. g. the correct spelling of Mandarin phonetic symbols for the Chinese character [symbol] (“water” in English word) should be [symbol] (“shui in English pronunciation)”, but if the set of incorrect Mandarin phonetic symbols is [symbol] (“sui” in English pronunciation)”, it will be deemed as an erroneous spelling of Mandarin phonetic symbols for the Chinese character [symbol] (“water” in English word) entered into the mobile phone by the user through the keypad 13 provided on the mobile phone, then all the Chinese characters liable to be mispronounced or misspelled as the Chinese character [symbol] (“shui” in English pronunciation) can be searched out from the aforesaid database cross reference table and subsequently be displayed on a display unit 14 of the mobile phone 10 for the user to choose the correct Chinese character needed for inputting into the mobile phone.

Referring to FIG. 1 again, the mobile phone 10 comprises the memory 11, the microprocessor 12, the keypad 13, the display unit 14 (e. g. a Liquid Crystal Display screen), a radio transceiver circuit 15, a loudspeaker 16, and a microphone 17, among which the microprocessor 12 is connected respectively to the memory 11, the keypad 13, the display unit 14, the radio transceiver circuit 15, the loudspeaker 16 and the microphone 17 so as to enable the user to enter his instructions and/or information by means of the keypad 13, and to cause the microprocessor 12 to execute the instructions and/or information it has received and to cause the instructions and/or information being executed or having been executed to be displayed on the display unit 14 in addition, the user may also make a voice communication with the person at the other end of the communication link by using the loudspeaker 16 and the microphone 17, and by enabling the radio transceiver circuit 15 to transmit and to receive the communication signals while the user is making conversation with his communication counterpart.

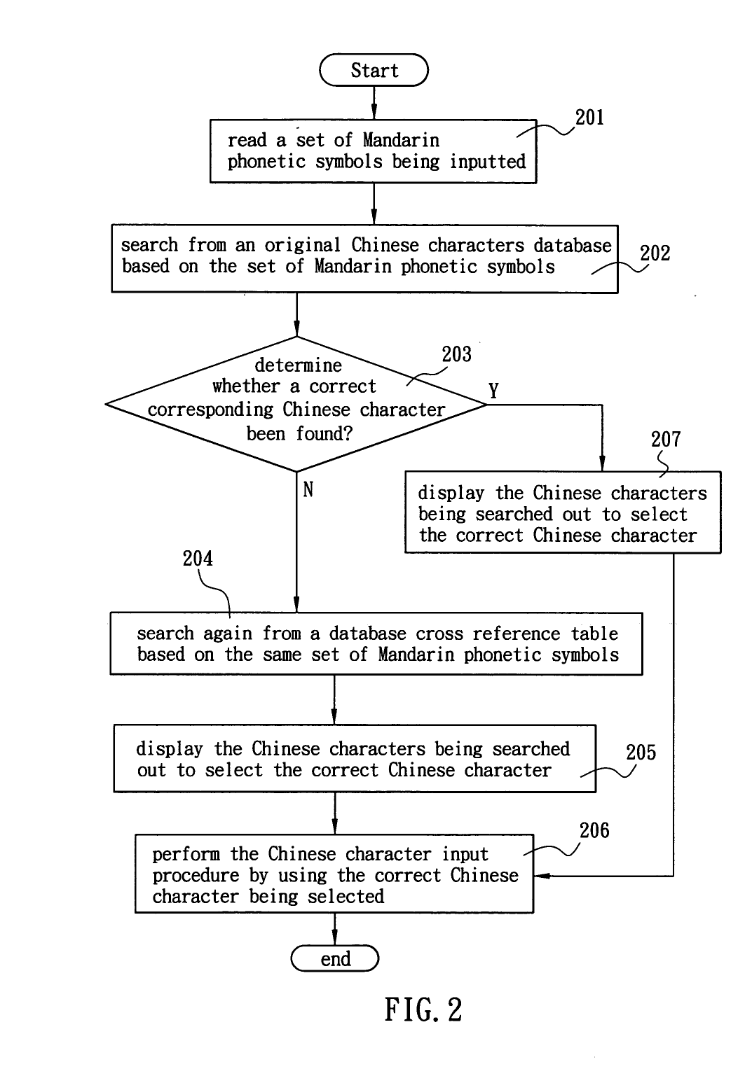

In the present invention (please refer to FIG. 1 and FIG. 2), when the mobile phone user uses the keypad 13 to input Chinese characters into the mobile phone 10, the microprocessor 12 will operate in accordance with the following operation steps:
(201) firstly, to read a set of Mandarin phonetic symbols being inputted by the user through the keypad 13 of the mobile phone 10;
(202) to search, based on the set of Mandarin phonetic symbols, from an original Chinese characters database for all the Chinese characters corresponding to such set of Mandarin phonetic symbols;
(203) to determine whether a correct corresponding Chinese character has been found in the original Chinese characters database, and if so, skip to Step (207), otherwise, go to Step (204);
(204) to search again, based on the same set of Mandarin phonetic symbols, from a database cross reference table established in that mobile phone 10 containing the Chinese characters liable to be misspelled or mispronounced for the correct Chinese character needed by the user;
(205) to display the Chinese characters being searched out from the relevant database cross-reference table on the display unit 14 for the user to select the correct Chinese character required;
(206) to perform the Chinese character input procedure by using the correct Chinese character being selected by the user, and then terminate the process; and
(207) to display all the Chinese characters being searched out from the original Chinese characters database on the display unit 14 for the user to select the correct Chinese character required, and then loop back to Step (206).

It is clear from the above description that the present invention is designed to provide a method for implementing a fuzzy spelling while inputting Chinese characters into a mobile phone through searching out all the relevant distinct (correct) and indistinct (incorrect) Chinese characters liable to be mispronounced or misspelled for a user to choose the correct one. Therefore, even if the user has initially mispronounced or misspelled a Chinese character [symbol] (“water” in English word) with an incorrect Mandarin phonetic symbols [symbol] (“shui” in English pronunciation)” and then inputted the incorrect one into the mobile phone, the mobile phone will still be able to search out all the relevant Chinese characters, liable to be mispronounced or misspelled into the incorrect one, from the database cross reference table and then to display the same on the display unit of the mobile phone for the user to select and input the correct Chinese character needed in an easy and fast manner.

While the invention herein disclosed has been described by means of specific embodiments, numerous modifications and variations could be made thereto by those skilled in the art without departing from the scope and spirit of the invention set forth in the claims.

What is claimed is:

1. A method for implementing a fuzzy spelling while inputting Chinese characters into a mobile phone, which classifies all Chinese characters into groups of Chinese characters liable to be mispronounced or misspelled in advance and stores said classified Chinese characters in a built-in memory in the mobile phone for establishing a database cross-reference table, comprising the steps of:
reading a set of mispronounced or misspelled Mandarin phonetic symbols inputted by the user through a keypad of the mobile phone;
searching all Chinese characters from the database cross-reference table corresponding to the set of inputted Mandarin phonetic symbols;
displaying all Chinese characters being searched on a display unit of the mobile phone for the user to select a correct character required; and
performing the Chinese character input procedure according to the correct Chinese character being selected.

2. According to the method as claimed in the claim 1, wherein the mobile phone further comprises a microprocessor being connected respectively with the memory, the keypad, the display unit, a radio transceiver circuit, a loudspeaker and a microphone, so as to input instructions and/or information into the mobile phone through the keypad, to execute the instructions and/or information by the microprocessor, to display the instructions and/or information being executed or having been executed on the display unit, to communicate with others at the other end of communication link of the mobile phone by using the loudspeaker and the microphone, and to transmit and receive the communication signals through the radio transceiver circuit.

3. According to the method as claimed in the claim 2, wherein the display unit may be a Liquid Crystal Display (LCD).
